(19) United States
(12) Patent Application Publication
(10) Pub. No.: US 2010/0192065 A1
(43) Pub. Date: Jul. 29, 2010

(54) METHOD FOR BROWSING VIDEO FILES

(75) Inventor: Ming-Chung Se, Taipei County (TW)

Correspondence Address: J C PATENTS, 4 VENTURE, SUITE 250, IRVINE, CA, 92618, US

(73) Assignee: Kinpo Electronics, Inc., Taipei County (TW)

(21) Appl. No.: 12/398,404

(22) Filed: Mar. 5, 2009

(30) Foreign Application Priority Data
Jan. 23, 2009 (TW) 98102950

(51) Int. Cl. G06F 3/048

(52) U.S. Cl. 715/719

(57) ABSTRACT

A method for browsing video files is provided. By utilizing the method, the end user could preview cover pages and dynamic images of video files on a television monitor simultaneously, and perform a browsing operation and capture a currently displayed image picture to be a cover page of the currently displayed video file through a remote control. Thereby, the user convenience on browsing the video files is improved.

### CROSS-REFERENCE TO RELATED APPLICATION

This application claims the priority benefit of Taiwan application serial no. 98102950, filed on Jan. 23, 2009. The entirety of the above-mentioned patent application is hereby incorporated by reference herein and made a part of this specification.

### BACKGROUND OF THE INVENTION

1. Field of the Invention

The present invention relates to a method of browsing video files, and more particularly, to a method of browsing cover pages and dynamic images simultaneously.

2. Description of Related Art

Along with the progressing evolution and improvements of electronic technology and the manufacturing techniques thereof, information products with more humanized features and powerful functions are continuously upgraded. Electronic products such as computers and digital cameras have become indispensable tools in life. In particular, along with combining a digital camera with a cell phone, digital cameras have gained a significant popularization rate. On the other hand, cell phones can also be used for video recording to record the details in daily lives anytime. Also, webcams are now the required peripheral devices of notebook computers. With the trend of audio/video sharing websites, users can download large amount of video files, movies, or audio/video shows via internet.

In the popularization stream of cell phones, digital cameras, and digital video cameras today, many people take advantage of digital cameras for recording interesting events in personal lives, or video recording growing processes of their children. As a consequence, a great deal of multimedia files accumulate gradually. However, when browsing large amount of video files, the end users have to open the files individually for watching the video contents therein, which are inconvenient for use. Currently, the liquid crystal (LC) televisions (TV), which in combination with storage media such as a hard disc, can store video files. Nevertheless, the LC TVs are different from computers, and can not provide the end users with simple video browsing interfaces. Hence, it is inconvenient for the end users to browse large amount of video files, for example, movies.

### SUMMARY OF THE INVENTION

The present invention provides a method of browsing video files. By utilizing the picture in picture (PIP) technique, the method allows the end user to browse cover pages of video files and dynamic images simultaneously. The end user can also perform a browsing operation and capture an image picture to be a cover page of the video file through a remote control. Thereby, the user convenience on browsing the video files is improved.

In light of the foregoing, a method of browsing video files suitable for a multimedia player is provided in the present invention. The method includes the following steps. Firstly, the video files and the corresponding cover pages that are saved in a storage medium are read. The cover pages are then sequentially displayed on a video picture displayed on the multimedia player. Moreover, sizes of the cover pages and a display layer order thereof are determined according to positions of the cover pages. The positions of the cover pages are shifted on the video picture, and a center cover page positioned at the center of the frame is magnified according to a browse signal. Thereafter, a sub-picture is disposed in a center region of the video picture. The sub-picture overlaps on the center cover page, and a corresponding video file is played in the sub-picture. The image picture played by the sub-picture is captured according to a capture signal for updating the center cover page.

In one embodiment of the present invention, the step of sequentially displaying the cover pages further includes modifying sizes of each cover page according to distances between the cover pages and the center of the video picture. Herein, the size of the center cover page positioned in the center of the frame is larger than those of other cover pages.

In one embodiment of the present invention, the browse signal and the cover page capture signal are generated by a TV remote control.

In one embodiment of the present invention, the method further includes updating the center cover page according to the captured image picture. Both the captured image picture and the center cover page correspond to the same video file.

In one embodiment of the present invention, the step of capturing the image picture played by the sub-picture further includes saving the captured image picture in a BMP format and setting the image picture to correspond to a first video file.

In one embodiment of the present invention, the step of sequentially displaying the cover pages which correspond to the video files further includes arranging the cover pages displayed in a horizontal manner.

In one embodiment of the present invention, the step of sequentially displaying the cover pages on the video picture further includes gradually adjusting a moving speed of the cover pages according to a user browsing speed.

In one embodiment of the present invention, the aforementioned method further includes displaying a sorting mark corresponding to the first video file in the video picture. The sorting mark includes a sorting name, a file name, a data parameter, and a file location.

In light of the foregoing, the PIP technique is utilized in the present invention for the TV or video picture to display the video files and the cover pages thereof simultaneously. In addition, the end user can preview large amount of video files directly with the TV remote control, and can directly capture the images of the video files to be the cover pages thereof.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of multimedia playing system according to an embodiment of the present invention.

FIG. 1B is a schematic diagram of a browsing frame according to an embodiment of the present invention.

FIG. 2 is a flowchart of a method of browsing video files according to the present embodiment.

FIG. 3 is a flowchart of a method of browsing video files according to another embodiment of the present invention.

### DESCRIPTION OF EMBODIMENTS

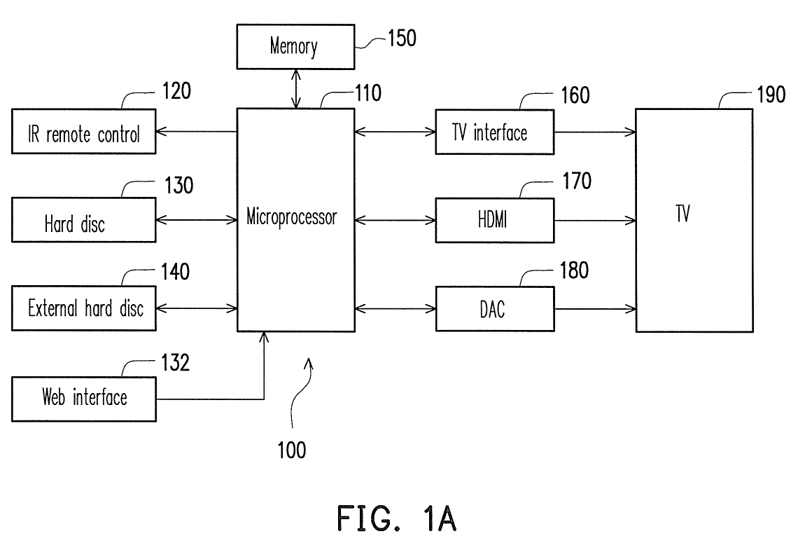

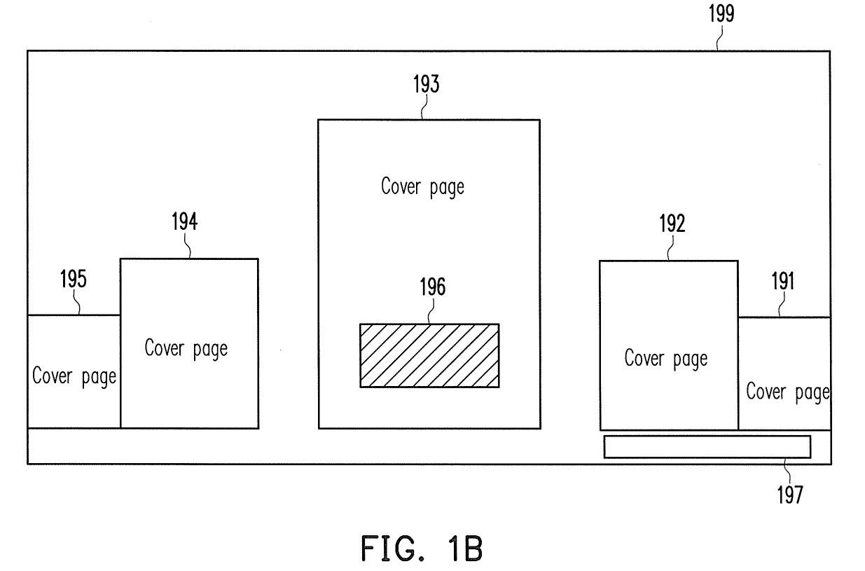

Referring to FIG. 1A, FIG. 1A is a block diagram of a multimedia playing system according to an embodiment of the present invention. A multimedia playing system 100 includes a microprocessor 110, an infrared (IR) remote control 120, a hard disc 130, an external hard disc 132, a web interface 140, a memory 150, a television (TV) interface 160, a high-definition multimedia interface (HDMI) 170, and a digital-to-analog converter (DAC) 180. The microprocessor 110 is coupled between the components aforementioned for reading data saved in the hard disc 130 or the memory 150, or for writing data into the hard disc 130, the external hard disc 132, or the memory 150. The TV interface 160, the HDMI 170, and the DAC 180 are mainly used to deliver multimedia files to a TV set 190 for displaying. The multimedia files are, for example, photos or video/audio files. Herein, the microprocessor 110, the IR remote control 120, the hard disc 130, the external hard disc 132, the web interface 140, the memory 150, the TV interface 160, the HDMI 170, and the DAC 180 can be integrated into a multimedia player, and can also be integrated with the TV set 190.

Taking movies as an example, after the end user saves movie files into the hard disc 130 or the external hard disc 132, the microprocessor 110 reads the movie video files saved in the hard disc 130 or the external hard disc 132 for sorting them based on the end user's demand. The multimedia playing system 100 provides an option list for sorting used for the end user to select the type of video files to be browsed. Moreover, related types of video files are searched for browsing according to the end user's demand. The microprocessor 110 reads the video files and the corresponding cover pages thereof saved in the hard disc 130 or the external hard disc 132. In general, the cover page and the video file would have the same name, and can or cannot be placed in the same folder. The system can thus confirm the cover page thereof with this property. If storage media such as the hard disc 130 or the external hard disc 132 include many movies, then the system can perform sorting to all video files and provide sorting options according to a sorting method set by the end user or to a preset sorting method. Therefore, the end user can browse the specific files rapidly.

The microprocessor 110 saves the relevant thumbnails and the indexes thereof to the memory 150, and then displays the cover pages sequentially on the video picture of the TV set 190. The cover pages are displayed in a horizontal arrangement. The end user can shift the cover pages sequentially to the left or to the right and display the cover pages alternately through a direction button on the TV remote control. At the same time, the multimedia playing system 100 determines the sizes and the display layer of the cover pages according to the position and the TV resolution output setting of each cover page. Herein, the size of the cover page becomes larger and is positioned at a higher level of the frame as it gets closer to the center region of the frame. On the contrary, the size of the cover page becomes smaller and is positioned at a lower level of the frame as it gets closer to the two sides of the frame. Therefore, when the displaying positions of the cover pages are overlapped, the cover pages closer to the center of the frame overlap on the cover pages closer to the sides of the frame.

Moreover, the cover page located in the center of the frame is called a center cover page. The multimedia playing system 100 disposes a sub-picture in the center region of the frame, and the sub-picture overlaps on the center cover page. The microprocessor 110 connects to the corresponding video file according to the center cover page and plays the video file in the sub-picture. When the center cover page changes, the corresponding video file played in the sub-picture changes as well. The microprocessor 100 applies the PIP technique to integrate the sub-picture and the center cover page into the same frame.

Referring to FIG. 1B, FIG. 1B is a schematic diagram of a browsing frame according to an embodiment of the present invention. Here, a video picture 199 is displayed on a monitor of the TV set 190, and the cover pages 191˜195 are respectively the representative images of different movies, i.e. Spider Man, Matrix, or Pirates of the Caribbean. The cover page 193 is located at the center of the video picture 199, and is thus the center cover page. Therefore, the size of the cover page 193 is then magnified to be the largest cover page. Also, a sub-picture 196 overlapped (or not-overlapped) on the cover page 193 plays the video file corresponding to the cover page 193. The end user can generate a browse signal directly with the button on the IR remote control in FIG. 1A, so as to slide the cover page to the left or the right. When the cover page positioned at the center of the frame changes, the video file displayed in the sub-picture 196 changes as well. When the end user slides the cover pages 191-195 to the left, the cover page 195 is slid outside of the frame. The right side of the frame is replaced with a new cover page, and the center cover page is changed to the cover page 192. On the contrary, the sliding of the cover pages to the right has the similar effect.

In the process of browsing, the system gradually adjusts a moving speed of the cover pages according to a user browsing speed (which is determined by the button on the remote control, i.e. the end user presses the direction button continually). Thereby, the end user can browse the cover pages of the movies and the video contents thereof with ease for selecting the movie needed. If the end user keeps pressing on the direction button, then the system gradually increases the speed for browsing the cover pages. Moreover, the system displays a file sorting prefix or a filing time of the current video file semi-transparently or opaquely, so that the end user can understand the current progress of cover page browsing. This displayed prefix or the filing time of the current video file is called a sorting mark.

In addition, when playing the video files, the end user can generate the capture signal through the button of the IR remote control 120 in FIG. 1A to capture the image picture in the sub-picture to be the cover page. The multimedia playing system 100 saves the captured image picture, and connects the captured image picture to the corresponding video files with a data base. The captured image picture is saved with the BMP format. Also, if the user captures a plurality of cover pages from the same movie, then the multimedia playing system 100 updates the cover pages on the frame (including the center cover page) periodically with the cover page captured. It should be noted that when displaying the cover page of the movie for the first time, if the movie file folder does not include the file of the cover page, the system then replaces the cover page thereof with a preset image.

On the other hand, a sorting mark 197 is displayed on the bottom right corner of the video picture 199. The sorting mark 197 includes information, such as the sorting name, the file name, the date parameter, and the file location, that corresponds to the center cover page. The sorting mark 197 can set the position or the display method according to the end user's demand while integrating the thumbnail to achieve a visual displaying effect. Through the sorting mark 197, the end user can conveniently access the relevant information of the video files currently being browsed. It should be noted that the cover pages 191˜195 in the video picture 199 are merely exemplary, and the present embodiment does not limit the number of cover pages displayed therein.

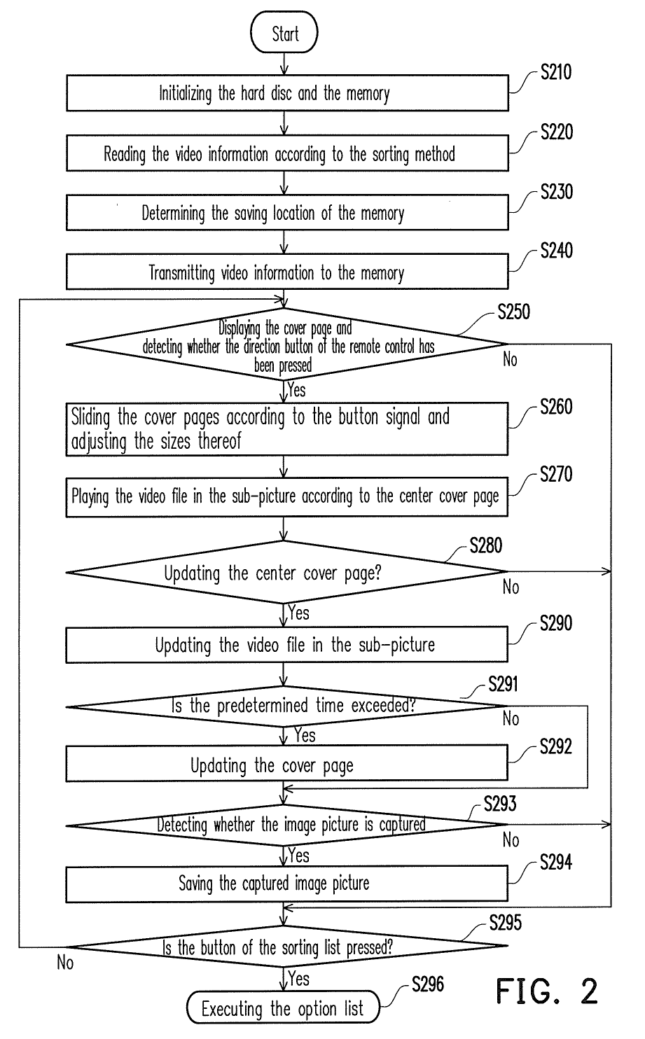

Next, a browsing method of the present embodiment is further illustrated with reference to a flowchart. Referring to FIG. 2 and FIG. 1A simultaneously, FIG. 2 is a flowchart of a method of browsing video files according to the present embodiment. Firstly, the hard disc 130 and the memory 150 are initialized (step S210), then the video information in the hard disc 130 or the external hard disc 132 are read according to the sorting method (step S220). Next, the saving location in the memory 150 is determined (step S230). Moreover, the video information is transmitted to the memory 150. The cover page is displayed on the TV set 190, and whether the direction button of the TV remote control is pressed by the end user is detected (step S250). If so, the cover page is slid according to a button signal of the remote control, and the size thereof is modified (step 260). Afterward, the video file is played in the sub-picture according to the center cover page (step 270). If not, then step 295 is proceeded to detect whether the option list button has been pressed.

While playing the video file, the system detects whether the center cover page has been updated (step S280). If the center cover page has changed, then the video file in the sub-picture is updated correspondingly (step S290). Here, if the video file being displayed includes a plurality of cover pages, the system then updates the cover page periodically (step S291, S292). Next, the system detects whether the end user outputs the capture signal with the TV remote control to capture the image picture (step S293). If so, then the system saves the captured image picture and connects the image picture to the corresponding video file. (step S294). In step S295, whether the end user has pressed the sorting option list button is detected; if so, then the sorting option list is executed (step S296).

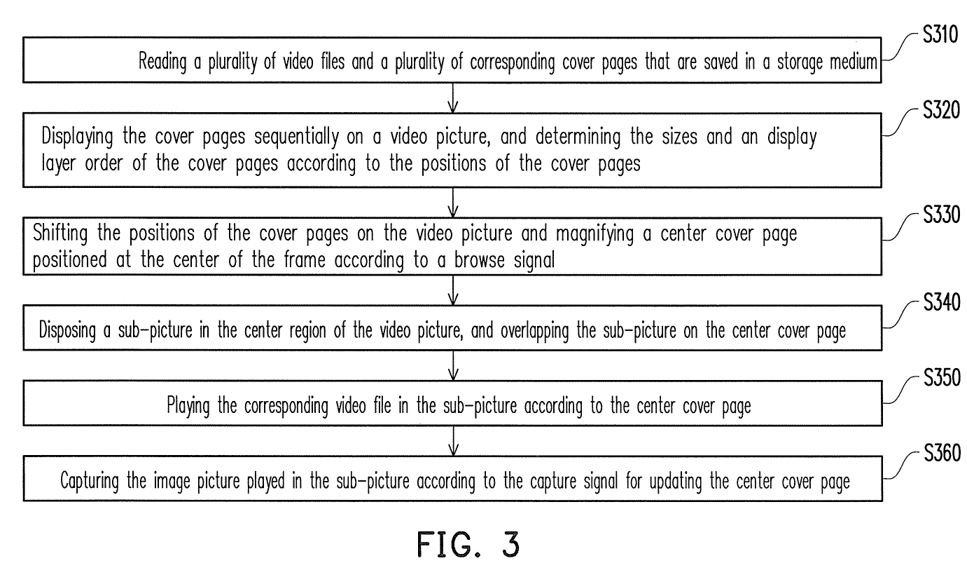

In summary, the present invention concludes a method of browsing video files. Referring to FIG. 3, FIG. 3 is a flowchart of a method of browsing video files according to another embodiment of the present invention. Firstly, a plurality of video files saved in the storage medium (hard disc or optical disc, etc) and the corresponding cover pages are read (step S310). After that, the cover pages are displayed sequentially on the video picture, and the sizes and the display layer order of the cover pages are determined according to the positions of the cover pages (step S320). Herein, the size of the center cover page located at the center of the frame is larger than those of the cover pages on the two sides. The display layer order can be used to illustrate the order of displayed layers in the video picture. The image on the top layer overlaps on the image on the button layer, so that the end user can have a gradational visual effect. In the displaying of the frame, the displaying position of each cover page and the fringes thereof have to be calculated for achieving the overlapping effect, such as the cover pages 191 and 192 in FIG. 1B.

Afterward, the position of the cover page is shifted on the video picture according to the browse signal (generated by the end user from operating the button of the remote control), and the center cover page positioned at the center of the frame is magnified (step S330). The system disposes a sub-picture in the center region of the video picture, and the sub-picture overlaps on the center cover page (step S340). Afterward, the video file corresponding to the center cover page is played in the sub-picture according to the center cover page (step S350). In the process of playing, the end user can capture the image picture in the sub-picture by directly pressing the button on the remote control for saving the image picture as the cover page. On the other hand, the end user can also slide the displaying cover pages by directly pressing the direction button on the remote control to gradually browse other cover pages that are not yet displayed. When the center cover page positioned at the center of the frame changes, the dynamic images played in the sub-picture then play the corresponding video files. Next, the system captures an image picture played by the sub-picture according to the capture signal for updating the center cover page or other cover pages (step S360). The end user can capture the image picture played by the sub-picture, which is used as the new cover page, by directly pressing the button on the remote control.

In addition, the above-mentioned embodiment is illustrated by merely using movies as an example. The present embodiment can be also used to browse videos recorded by the end user or videos downloaded from the internet. The present invention is not limited to the types of the video files. The functions referred in the flowcharts in FIG. 2 and FIG. 3 may be achieved by utilizing a firmware. Alternatively, a digital signal processor, for example, may be employed for the aforementioned microprocessor 110. In FIG. 1, the TV set 190 is, for example, a liquid crystal display (LCD) TV. The components other than the TV set 190 can be integrated into a multimedia player or be directly integrated into the TV, and the present embodiment does not limit the integrating method therein. Moreover, the method described in FIG. 3 is suitable for all kinds of video playing software or hardware, such as computers, Media Player under the Windows operation system, etc. Based on the disclosure of the present invention, other applications of said method can be easily deduced by persons of ordinary skill in the art, and a detailed description thereof is omitted herein.

In summary, the present invention applies the PIP technique to integrate the cover pages and the dynamic images, so that the end user can browse the video files on the TV and capture the cover pages needed. The present invention provides the TV with a more convenient browsing function. Moreover, the techniques of the present invention can also be utilized for integrating the hard-disc disposed inside of the TV or the hard-disc disposed in the multimedia player to increase the commercial values thereof.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of browsing video files suitable for a multimedia player, comprising:
reading a plurality of video files saved in a storage medium and a plurality of corresponding cover pages;
displaying the plurality of cover pages sequentially on a video picture, and determining a size and a display layer order of the plurality of cover pages according to a position of the plurality of cover pages;
shifting the position of the plurality of cover pages on the video picture and magnifying a center cover page positioned at a center of the video picture according to a browse signal;
disposing a sub-picture in a center region of the video picture, and the sub-picture overlapping on the center cover page;
playing a corresponding first video file in the sub-picture according to the center cover page; and
capturing an image picture played by the sub-picture according to a capture signal for updating the center cover page.

2. The method of browsing video files as claimed in claim 1, wherein the step of displaying the plurality of cover pages sequentially further comprises modifying the size of each cover page according to distances between the plurality of cover pages and the center of the video picture, wherein a size of the center cover page is larger than those of the other cover pages.

3. The method of browsing video files as claimed in claim 1, wherein the browse signal and the capture signal are generated by a television remote control.

4. The method of browsing video files as claimed in claim 1, further comprising updating the center cover page periodically according to the captured image picture, wherein both the image picture and the center cover page correspond to the first video file.

5. The method of browsing video files as claimed in claim 1, wherein the step of capturing the image picture played by the sub-picture further comprises saving the captured image picture in a bitmap format and setting the image picture to correspond to the first video file.

6. The method of browsing video files as claimed in claim 1, wherein the step of sequential displaying the plurality of cover pages corresponding to the plurality of video files further comprises arranging the plurality of cover pages displayed in a horizontal manner.

7. The method of browsing video files as claimed in claim 1, wherein the step of displaying the plurality of cover pages sequentially on the video picture further comprises
gradually adjusting a moving speed of the plurality of cover pages according to a user browsing speed.

8. The method of browsing video files as claimed in claim 1, further comprising:
displaying a sorting mark corresponding to the first video file in the video picture, wherein the sorting mark comprises a sorting name, a file name, a date parameter, a file sorting prefix, or a file location.

9. The method of browsing video files as claimed in claim 1, wherein the step of reading the plurality of video files and the plurality of cover pages saved in the storage medium further comprises
reading the plurality of video files and the plurality of cover pages according to a sorting option.

10. The method of browsing video files as claimed in claim 1, wherein the storage medium is a hard disc.
